(19) United States
(12) Patent Application Publication
(10) Pub. No.: US 2019/0315361 A1
(43) Pub. Date: Oct. 17, 2019

(54) APPARATUS AND METHOD FOR CONTROLLING LANE CHANGE IN VEHICLE

(71) Applicants: HYUNDAI MOTOR COMPANY, Seoul (KR); KIA MOTORS CORPORATION, Seoul (KR)

(72) Inventors: Sung Min PARK, Seoul (KR); Na Eun YANG, Hwaseongsi (KR); Jin Su JEONG, Suwon-si (KR)

(73) Assignees: HYUNDAI MOTOR COMPANY, Seoul (KR); KIA MOTORS CORPORATION, Seoul (KR)

(21) Appl. No.: 16/204,400

(22) Filed: Nov. 29, 2018

Related U.S. Application Data
(60) Provisional application No. 62/655,831, filed on Apr. 11, 2018.

(30) Foreign Application Priority Data
Sep. 7, 2018 (KR) 10-2018-0107268

(51) Int. Cl. B60W 30/18; B60W 50/12; B60W 30/09; B60W 30/095; G08G 1/16

(52) U.S. Cl. CPC B60W 30/18163; B60W 50/12; B60W 30/09; B60W 2720/10; G08G 1/167; B60W 2550/308; B60W 2550/302; B60W 30/0956

(57) ABSTRACT

An apparatus for controlling a lane change in a vehicle includes: a sensor to sense an external vehicle, an input device to receive a lane change command from a driver of the vehicle, and a control circuit to be electrically connected with the sensor and the input device. The control circuit may receive the lane change command using the input device, calculate a minimum operation speed of the vehicle for a lane change control, and determine whether to accelerate the vehicle based on a speed of a preceding vehicle which is traveling on the same lane as the vehicle, when a driving speed of the vehicle is lower than the minimum operation speed.

### CROSS-REFERENCE TO RELATED APPLICATIONS

This application claims priority to and the benefit of Korean Patent Application No. 10-2018-0107268, filed on Sep. 7, 2018, which claims priority to and the benefit of U.S. Patent Application No. 62/655,831, filed on Apr. 11, 2018, the entirety of each of which are incorporated herein by reference.

### FIELD

The present disclosure relates to an apparatus and method for adjusting a speed of a vehicle to control a lane change.

### BACKGROUND

The statements in this section merely provide background information related to the present disclosure and may not constitute prior art.

With the development of the auto industry, a lane change control system capable of automatically changing a lane on which a vehicle is traveling has been developed. When a driver operates a turn signal with the intention of changing a lane, the lane change control system may perform a lane change by automatically controlling a vehicle in a horizontal direction toward a direction where the turn signal is turned on. The lane change control system may perform a lane change by determining whether a speed, a location, and the like of a surrounding vehicle are suitable for performing the lane change, setting a control path for the lane change, and controlling steering torque along the control path. The lane change control system may detect a preceding vehicle and a following vehicle and may perform control based on the obtained information.

We have discovered that when a driving speed of a vehicle is slower, lane change control may put a driver in danger, and the driver may set a minimum operation speed capable of performing lane change control. In addition, when the minimum operation speed is set, while the vehicle travels at a speed slower than the minimum operation speed, when a lane change command of the driver is generated, we have discovered that a control strategy is desired to accelerate the vehicle to the minimum operation speed or more.

### SUMMARY

An aspect of the present disclosure provides an apparatus and method for controlling a lane change in a vehicle to provide a strategy for lane change control when a driving speed of the vehicle is lower than a minimum operation speed.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling a lane change in a vehicle may include: a sensor configured to sense an external vehicle, an input device configured to receive a lane change command from a driver of the vehicle, and a control circuit configured to be electrically connected with the sensor and the input device. The control circuit may be configured to receive the lane change command using the input device, calculate a minimum operation speed of the vehicle for a lane change control, and determine whether to accelerate the vehicle based on a speed of a preceding vehicle which is traveling on the same lane as the vehicle, when a driving speed of the vehicle is lower than the minimum operation speed.

The control circuit may be configured to calculate the minimum operation speed in response to receiving the lane change command.

The control circuit may be configured to calculate the minimum operation speed periodically while the vehicle travels.

The control circuit may be configured to, when a following vehicle which is traveling on a target lane corresponding to the lane change command is sensed by the sensor, calculate the minimum operation speed based on a speed of the following vehicle and a distance between the vehicle and the following vehicle.

The control circuit may be configured to, when a following vehicle which is traveling on a target lane corresponding to the lane change command is not sensed by the sensor, calculate the minimum operation speed based on a predetermined speed for traveling vehicles and a sensing distance corresponding to a maximum distance sensible by the sensor.

The control circuit may be configured to control the vehicle such that the driving speed of the vehicle is higher than the minimum operation speed, when the minimum operation speed is lower than the speed of the preceding vehicle and perform the lane change control.

The control circuit may be configured to control the vehicle such that the driving speed of the vehicle is higher than the minimum operation speed, when the preceding vehicle is not sensed by the sensor and perform the lane change control.

The control circuit may be configured to determine whether to accelerate the vehicle based on the speed of the preceding vehicle and a distance between the vehicle and the preceding vehicle, when the minimum operation speed is higher than the speed of the preceding vehicle.

The control circuit may be configured to determine a probability of collision between the vehicle and the preceding vehicle based on the speed of the preceding vehicle and the distance between the vehicle and the preceding vehicle, control the vehicle such that the driving speed of the vehicle is higher than the minimum operation speed, when there is no the probability of collision, and perform the lane change control.

The control circuit may be configured to estimate a predicted driving path of the vehicle and a predicted driving path of the preceding vehicle based on the speed of the preceding vehicle and the distance between the vehicle and the preceding vehicle and determine the probability of collision between the vehicle and the preceding vehicle based on the predicted driving path of the vehicle and the predicted driving path of the preceding vehicle.

The control circuit may be configured to determine a probability of collision between the vehicle and the preceding vehicle based on the speed of the preceding vehicle and the distance between the vehicle and the preceding vehicle and control the vehicle to decelerate, when there is the probability of collision.

The control circuit may be configured to determine the probability of collision, after the vehicle decelerates.

The control circuit may be configured to calculate the minimum operation speed again, after the vehicle decelerates.

According to another aspect of the present disclosure, a method for controlling a lane change of a vehicle may include: receiving, by a control circuit, a lane change command from a driver of the vehicle; calculating, by the control circuit, a minimum operation speed of the vehicle for a lane change control; and determining, by the control circuit, whether to accelerate the vehicle based on a speed of a preceding vehicle which is traveling on the same lane as the vehicle, when a driving speed of the vehicle is lower than the minimum operation speed.

The calculating the minimum operation speed may include, when a following vehicle which is traveling on a target lane corresponding to the lane change command is sensed, calculating the minimum operation speed based on a speed of the following vehicle and a distance between the vehicle and the following vehicle.

The calculating of the minimum operation speed may include, when a following vehicle which is traveling on a target lane corresponding to the lane change command is not sensed, calculating the minimum operation speed based on a predetermined speed of traveling vehicles set by a country where the vehicle is located, and a sensing distance corresponding to a maximum distance sensible by a sensor of the vehicle.

The method may further include controlling, by the control circuit, the vehicle such that the driving speed of the vehicle is higher than the minimum operation speed, when the minimum operation speed is lower than the speed of the preceding vehicle and performing the lane change control.

The method may further include controlling, by the control circuit, the vehicle such that the driving speed of the vehicle is higher than the minimum operation speed, when the preceding vehicle is not sensed and performing the lane change control.

The determining whether to accelerate the vehicle may include determining, by the control circuit, whether to accelerate the vehicle based on the speed of the preceding vehicle and a distance between the vehicle and the preceding vehicle, when the minimum operation speed is higher than the speed of the preceding vehicle.

The method may further include determining, by the control circuit, a probability of collision between the vehicle and the preceding vehicle based on the speed of the preceding vehicle and the distance between the vehicle and the preceding vehicle, controlling the vehicle such that the driving speed of the vehicle is higher than the minimum operation speed, when there is no the probability of collision, and performing the lane change control.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of an apparatus for controlling a lane change in a vehicle;

FIG. 2 is a drawing illustrating an exemplary operation of an apparatus for controlling a lane change in a vehicle;

FIG. 3 is a drawing illustrating an exemplary operation of an apparatus for controlling a lane change in a vehicle;

FIG. 4 is a drawing illustrating an exemplary operation of an apparatus for controlling a lane change in a vehicle;

FIG. 5 is a drawing illustrating an exemplary operation of an apparatus for controlling a lane change in a vehicle;

FIG. 6 is a drawing illustrating an exemplary operation of an apparatus for controlling a lane change in a vehicle;

FIG. 7 is a drawing illustrating an exemplary operation of an apparatus for controlling a lane change in a vehicle;

FIG. 8 is a drawing illustrating an exemplary operation for determining a probability of collision in an apparatus for controlling a lane change in a vehicle;

FIG. 9 is a drawing illustrating an exemplary operation for determining a probability of collision in an apparatus for controlling a lane change in a vehicle;

FIG. 10 is a flowchart illustrating a method for controlling a lane change in a vehicle;

FIG. 11 is a flowchart illustrating a method for controlling a lane change in a vehicle; and

FIG. 12 is a block diagram illustrating a configuration of a computing system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, in describing an exemplary form of the present disclosure, if it is determined that a detailed description of related well-known configurations or functions blurs the gist of the present disclosure, it will be omitted.

In describing elements of forms of the present disclosure, the terms 1^{st}, 2^{nd}, first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

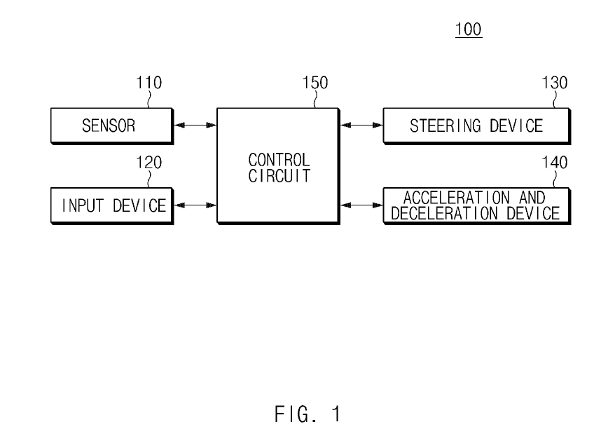

FIG. 1 is a block diagram illustrating a configuration of an apparatus for controlling a lane change in a vehicle in one form of the present disclosure.

Referring to FIG. 1, an apparatus 100 for controlling a lane change in a vehicle (hereinafter referred to as “apparatus 100” for convenience of description) may include a sensor 110, an input device 120, a steering device 130, an acceleration and deceleration device 140, and a control circuit 150. The apparatus 100 of FIG. 1 may be loaded into the vehicle.

The sensor 110 may be configured to sense an external vehicle. The sensor 110 may include, for example, a forward sensor 110 and a blind spot assist (BSA) sensor (or a rear lateral sensor) 110. The sensor 110 may sense a preceding vehicle which is traveling on the same lane as the vehicle and a following vehicle which is traveling on a lane adjacent to the vehicle.

The input device 120 may configured to receive a lane change command from a driver of the vehicle. The input device 120 may be implemented with, for example, a turn signal lever, a switch, a button, or the like capable of receiving an input of the driver.

The steering device 130 may be configured to control a steering angle of the vehicle. The steering device 130 may include, for example, a steering wheel, an actuator interlocked with the steering wheel, and a controller for controlling the actuator.

The acceleration and deceleration device 140 may be configured to control a speed of the vehicle. The acceleration and deceleration device 140 may include, for example, a throttle, a brake, an actuator interlocked with the throttle and the brake, and a controller for controlling the actuator.

The control circuit 150 may be electrically connected with the sensor 110, the input device 120, the steering device 130, and the acceleration and deceleration device 140. The control circuit 150 may control the sensor 110, the input device 120, the steering device 130, and the acceleration and deceleration device 140 and may perform a variety of data processing and various arithmetic operations. The control circuit 150 may be, for example, an electronic control unit (ECU) or a sub-controller loaded into the vehicle.

According to an exemplary form, the control circuit 150 may receive a lane change command using the input device 120. The control circuit 150 may receive a lane change command in a left or right direction via the input device 120 from the driver.

In one form, the control circuit 150 may calculate a minimum operation speed for lane change control. For example, the control circuit 150 may calculate a minimum operation speed in response to receiving a lane change command or may calculate a minimum operation speed periodically while the vehicle travels. Upon lane change control, the apparatus 100 may activate control only when a driving speed of the vehicle is greater than or equal to the minimum operation speed for a safe lane change. An exemplary equation for calculating a minimum operation speed Vₛₘᵢₙ may be Equation 1 below.

Vₛₘᵢₙ=a*(t_{B}−t_{G})+vₐₚₚ−\sqrt{a²*(t_{B}−t_{G})²−2*a*(vₐₚₚ*t_{G}−Sᵣₑₐᵣ)} [Equation 1]

According to Equation 1 above, the minimum operation speed Vₛₘᵢₙ may be determined based on Sᵣₑₐᵣ, Vₐₚₚ, a, t_{B}, and t_{G}. Herein, each of a, t_{B}, and t_{G} may be a kind of environmental variable indicating a predicted behavior of a following vehicle and may correspond to a predefined constant. Each of the distance Sᵣₑₐᵣ between the vehicle and the following vehicle and the speed Vₐₚₚ of the following vehicle may be a value indicating a motion state of the following vehicle and may be measured by the sensor 110.

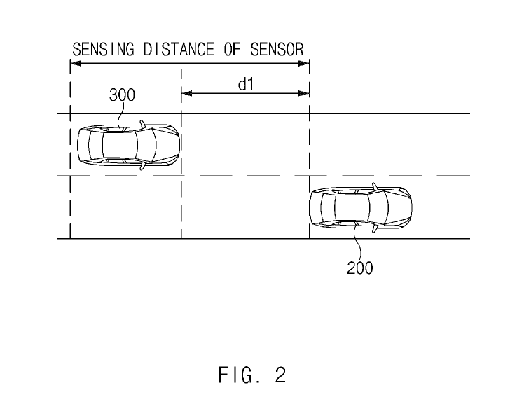

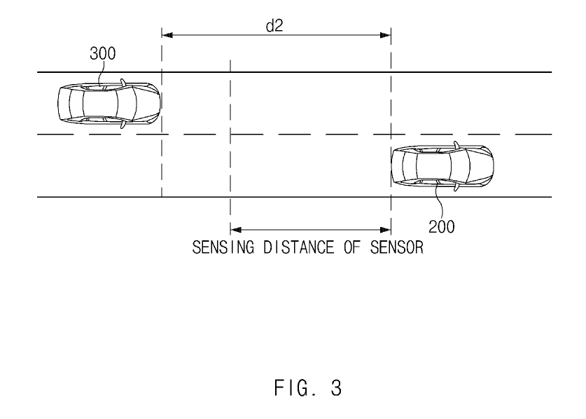

Herein, a sensing distance of the sensor 110 is limited, so there may be a need for calculating the minimum operation speed Vₛₘᵢₙ for each of when the following vehicle is located within the sensing distance of the sensor 110 and when the following vehicle is not located within the sensing distance of the sensor 110. When the following vehicle is located within the sensing distance, the control circuit 150 may calculate the minimum distance Vₛₘᵢₙ based on the distance Sᵣₑₐᵣ and the speed Vₐₚₚ measured by the sensor 110. When the following vehicle is not located within the sensing distance, the control circuit 150 may calculate the minimum distance Vₛₘᵢₙ assuming that there is the worst, that is, the following vehicle proceeds at a maximum legal speed immediately over the sensing distance of the sensor 110. In this case, the control circuit 150 may set the distance Sᵣₑₐᵣ to a maximum sensing distance of the sensor 110 and may set the speed Vₐₚₚ to a maximum legal speed of a country where a vehicle is traveling. A description will be given in detail of an exemplary form of calculating the minimum operation speed with reference to FIGS. 2 and 3.

When a current speed of the vehicle is faster than the minimum operation speed, the control circuit 150 may immediately initiate lane change control. When the current speed of the vehicle is slower than the minimum operation speed, the control circuit 150 may provide various control strategies in consideration of a preceding vehicle.

According to an exemplary form, when a driving speed of the vehicle is lower than the minimum operation speed, the control circuit 150 may determine whether to accelerate the vehicle based on a speed of a preceding vehicle which is traveling on the same lane as the vehicle. In a situation where the vehicle should accelerate its driving speed to reach the minimum operation speed to activate lane change control, the control circuit 150 may divide a surrounding situation into four situations and may provide a control strategy suitable for each of the four situations. The control circuit 150 may suitably accelerate or decelerate the vehicle and may perform lane change control by controlling the steering device 130 and the acceleration and deceleration device 140.

TABLE 1

| Case | Control strategy |
|---|---|
| When there is no | Accelerate the vehicle to Vₛₘᵢₙ or more and |
| preceding vehicle | perform lane change control |
| When speed V_{f} of | Accelerate the vehicle to Vₛₘᵢₙ or more and |
| the preceding | perform lane change control |
| vehicle > Vₛₘᵢₙ | |
| When V_{f} < V_{smin and} | Accelerate the vehicle to Vₛₘᵢₙ or more and |
| when there is no | perform lane change control |
| probability of | |
| collision | |
| When V_{f} < Vₛₘᵢₙ and | Decelerate the vehicle |
| when there is | Retry lane change control after a distance |
| probability of | from the preceding vehicle is sufficiently |
| collision | provided or after the following vehicle |
| | overtakes the vehicle |

First of all, the control circuit 150 may verify whether the minimum operation speed is higher than a driving speed of the vehicle. When the driving speed of the vehicle is higher than the minimum operation speed, the control circuit 150 may immediately initiate a lane change. When the driving speed of the vehicle is lower than the minimum operation speed, the control circuit 150 may perform lane change control depending on the control strategy disclosed in Table 1 above.

The control circuit 150 may verify whether there is a preceding vehicle using the sensor 110. When the preceding vehicle is not detected, the control circuit 150 may sufficiently accelerate the vehicle, thus accelerating the vehicle to the minimum operation speed or more to change a lane.

When the preceding vehicle is detected, the control circuit 150 may verify a speed of the preceding vehicle. When the speed of the preceding vehicle is higher than the minimum operation speed, since there is no collision risk although the control circuit 150 accelerates the vehicle, the control circuit 150 may accelerate the vehicle to the minimum operation speed or more and may change a lane.

When the speed of the preceding vehicle is lower than the minimum operation speed, the control circuit 150 may consider a speed of the preceding vehicle and a headway between the vehicle and the preceding vehicle. Since the headway is sufficiently long, when there is no probability of collision while the vehicle accelerates and changes a lane, the control circuit 150 may accelerates the vehicle to the minimum operation speed or more and may change a lane.

Since the headway is not sufficiently long, when there is a probability of collision while the vehicle accelerates and changes a lane, the control circuit 150 may decelerates the vehicle. After a following vehicle overtakes the vehicle or after a distance from the preceding vehicle is provided, the control circuit 150 may retry lane change control.

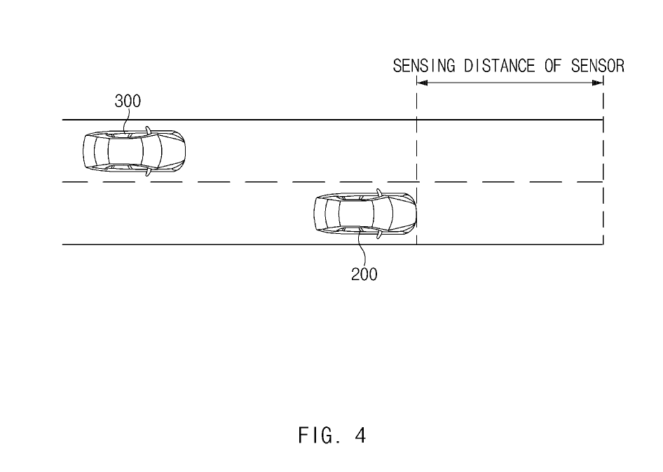

A description will be given in detail of each of the above-mentioned control strategies with reference to FIGS. 4 to 7.

Hereinafter, a description will be given in detail of an operation of calculating the minimum operation speed with reference to FIGS. 2 and 3.

FIG. 2 is a drawing illustrating an exemplary operation of an apparatus for controlling a lane change in a vehicle according to an exemplary form of the present disclosure.

Referring to FIG. 2, a vehicle 200 may include an apparatus 100 of FIG. 1. In a description of FIGS. 2 to 9, an operation described as being performed by the vehicle 200 may be understood as being controlled by a control circuit 150 of the apparatus 100.

In one form, when a following vehicle 300 which is traveling on a target lane corresponding to a lane change command is sensed by a sensor of the vehicle 200, the vehicle 200 may calculate a minimum operation speed based on a speed of the following vehicle 300 and a distance between the vehicle 200 and the following vehicle 300. For example, when a distance d1 between the vehicle 200 and the following vehicle 300 is shorter than a maximum sensing distance of a BSA sensor (or a rear lateral sensor), the vehicle 200 may measure a distance Sᵣₑₐᵣ and a speed Vₐₚₚ using the sensor. The vehicle 200 may calculate a minimum operation speed for lane change control based on the measured Sᵣₑₐᵣ and Vₐₚₚ. For example, the vehicle 200 may calculate the minimum operation speed by applying the measured Sᵣₑₐᵣ and Vₐₚₚ to Equation 1 above. When a lane change command is input, the vehicle 200 may calculate a minimum operation speed by detecting the following vehicle 300 in a lane to be changed or may calculate a minimum operation speed by detecting the following vehicle 3000 in a lane adjacent to the vehicle 200.

FIG. 3 is a drawing illustrating an exemplary operation of an apparatus for controlling a lane change in a vehicle according to another form of the present disclosure.

Referring to FIG. 3, when a following vehicle 300 which is traveling on a target lane corresponding to a lane change command is not sensed by a sensor of a vehicle 200 according to an exemplary form, the vehicle 200 may calculate a minimum operation speed based on a specified speed and a sensing distance of the sensor. For example, when a distance d2 between the vehicle 200 and the following vehicle 300 is longer than a maximum sensing distance of a BSA sensor (or a rear lateral sensor), the vehicle 200 may fail to measure a distance Sᵣₑₐᵣ and a speed Vₐₚₚ using the sensor. In this case, the vehicle 200 may calculate a minimum operation speed Vₛₘᵢₙ assuming that the following vehicle 300 proceeds at a maximum legal speed immediately over a sensing distance of the sensor. The vehicle 200 may set the distance Sᵣₑₐᵣ to a maximum sensing distance of the sensor and may set the speed Vₐₚₚ to a maximum legal speed of a country where the vehicle 200 is traveling. The vehicle 200 may calculate a minimum operation speed by applying the set Sᵣₑₐᵣ and Vₐₚₚ to Equation 1 above. When a lane change command is input, the vehicle 200 may calculate a minimum operation speed by detecting the following vehicle 300 in a lane to be changed or may calculate a minimum operation speed by detecting the following vehicle 300 in a lane adjacent to the vehicle 200.

Hereinafter, a description will be given in detail of a control strategy provided when a preceding vehicle is not detected, with reference to FIG. 4.

FIG. 4 is a drawing illustrating an exemplary operation of an apparatus for controlling a lane change in a vehicle according to one form of the present disclosure.

Referring to FIG. 4, when a preceding vehicle is not sensed by a sensor of a vehicle 200, the vehicle 200 may control a driving speed of the vehicle 200 to be higher than a minimum operation speed and may perform lane change control when the driving speed of the vehicle 200 is higher than the minimum operation speed. When the preceding vehicle is not located within a sensing distance of a forward sensor, the vehicle 200 may fail to detect the preceding vehicle. When the preceding vehicle is not located within the sensing distance of the sensor, since the vehicle 200 sufficiently accelerates its driving speed, it may accelerate the driving speed to a minimum operation speed and may change a lane.

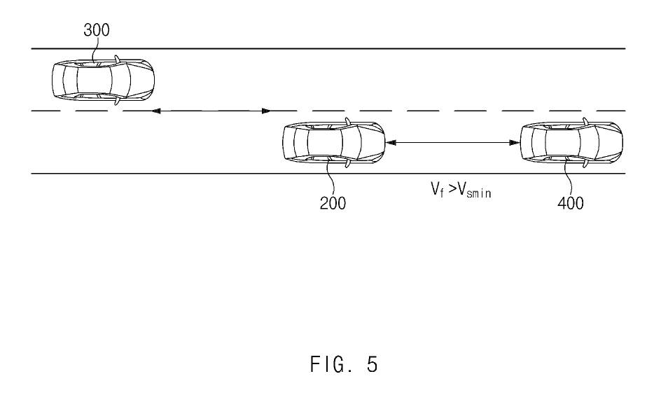

Hereinafter, a description will be given of a control strategy when a preceding vehicle is detected with reference to FIGS. 5 to 8.

FIG. 5 is a drawing illustrating an exemplary operation of an apparatus for controlling a lane change in a vehicle according to another exemplary form of the present disclosure.

Referring to FIG. 5, when a minimum operation speed Vₛₘᵢₙ is lower than a speed V_{f} of a preceding vehicle 400, a vehicle 200 may control its driving speed to be higher than the minimum operation speed Vₛₘᵢₙ and may perform lane change control when the driving speed of the vehicle 200 is higher than the minimum operation speed Vₛₘᵢₙ. When the preceding vehicle 400 is located within a sensing distance of a forward sensor, the vehicle 200 may detect a speed of the preceding vehicle 400. When the speed V_{f} of the preceding vehicle 400 is faster than the minimum operation speed Vₛₘᵢₙ, since the vehicle 200 sufficiently accelerates its driving speed, it may accelerate the driving speed to the minimum operation speed Vₛₘᵢₙ and may change a lane.

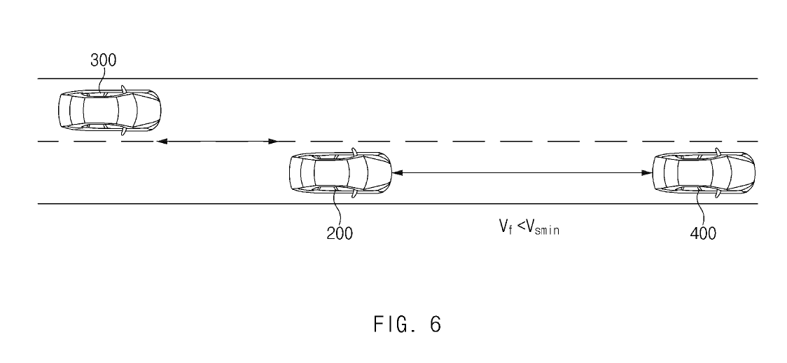

FIG. 6 is a drawing illustrating an exemplary operation of an apparatus for controlling a lane change in a vehicle according to another form of the present disclosure.

Referring to FIG. 6, when a minimum operation Vₛₘᵢₙ is higher than a speed V_{f} of a preceding vehicle 400, a vehicle 200 may determine whether to accelerate based on a speed of the preceding vehicle 400 and a distance between the vehicle 200 and the preceding vehicle 400. When the preceding vehicle 400 is located within a sensing distance of a forward sensor, the vehicle 200 may sense the speed V_{f} of the preceding vehicle 400. When the speed V_{f} of the preceding vehicle 400 is slower than the minimum operation speed Vₛₘᵢₙ, the vehicle 200 is unable to sufficiently accelerate its driving speed, so it may determine whether to accelerate in consideration of a headway between the vehicle 200 and the preceding vehicle 400.

According to an exemplary form, the vehicle 200 may determine a probability of collision between the vehicle 200 and the preceding vehicle 400 based on the speed V_{f} of the preceding vehicle 400 and a distance between the vehicle 200 and the preceding vehicle 400. When there is no the probability of collision, the vehicle 200 may control its driving speed to be higher than the minimum operation speed Vₛₘᵢₙ and may perform lane change control when the driving speed of the vehicle 200 is higher than the minimum operation speed Vₛₘᵢₙ. The vehicle 200 may predict a driving path of the vehicle 200 and a driving path of the preceding vehicle 400 until a lane change is completed. When there is no probability of collision with the preceding vehicle 400 since a headway is long as a result of the prediction, the vehicle 200 may accelerate its driving speed to the minimum operation speed Vₛₘᵢₙ and may change a lane along the predicted driving speed.

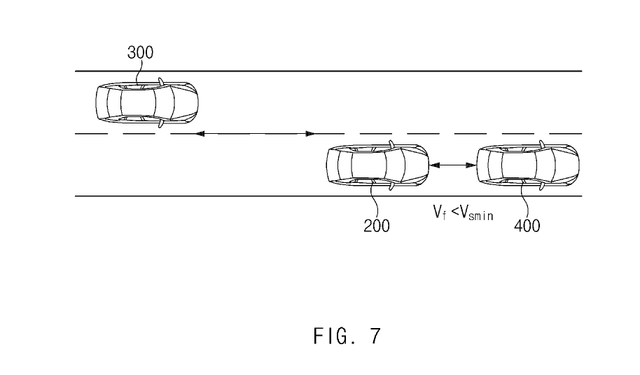

FIG. 7 is a drawing illustrating an exemplary operation of an apparatus for controlling a lane change in a vehicle according to another aspect of the present disclosure.

Referring to FIG. 7, a vehicle 200 may determine a probability of collision between the vehicle 200 and a preceding vehicle 400 based on a speed V_{f} of the preceding vehicle 400 and a distance between the vehicle 200 and the preceding vehicle 400. When there is the probability of collision, the vehicle 200 may control its driving speed to decelerate. The vehicle 200 may predict its driving path and a driving path of the preceding vehicle 400 until a lane change is completed. When there is a probability of collision with the preceding vehicle 400 since a headway is short as a result of the prediction, the vehicle 200 may perform deceleration control. After the vehicle 200 decelerates, it may determine the probability of collision again and may calculate a minimum operation speed again. The vehicle 200 may provide a headway and may allow a following vehicle 300 to overtake the vehicle 200 by decelerating. After a headway is sufficiently provided or a minimum operation speed is reset after the following vehicle 300 overtakes the vehicle 200, the vehicle 200 may retry a lane change.

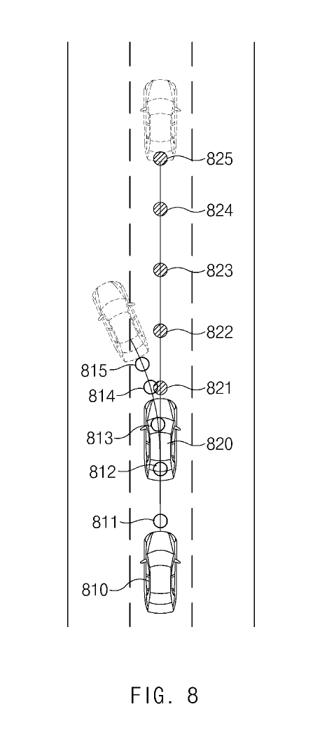

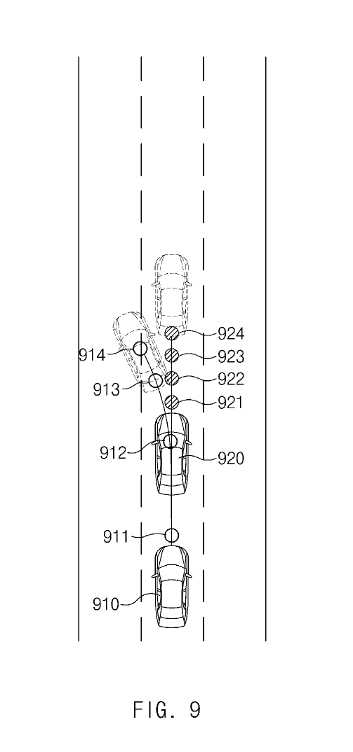

Hereinafter, a description will be given in detail of an operation of determining a probability of collision with reference to FIGS. 8 and 9.

FIGS. 8 and 9 are drawings illustrating an exemplary operation for determining a probability of collision in an apparatus for controlling a lane change in a vehicle according to an exemplary form of the present disclosure.

According to one form, a vehicle may estimate its predicted driving path and a predicted driving path of a preceding vehicle based on a speed of the preceding vehicle and a distance between the vehicle and the preceding vehicle and may determine a probability of collision between the vehicle and the preceding vehicle based on the predicted driving path of the vehicle and the predicted driving path of the preceding vehicle.

Referring to FIG. 8, a vehicle 810 may recognize a preceding vehicle 820, a driving lane, and a target lane. The vehicle 810 may predict a path where the vehicle 810 accelerates to a minimum operation speed and changes a lane and may predict a path of the preceding vehicle 820. The vehicle 810 may verify whether paths are duplicated. When the paths are duplicated, the vehicle 810 may determine that there is a probability of collision between the vehicle 810 and the preceding vehicle 820. When the paths are not duplicated, the vehicle 810 may determine that there is no probability of collision between the vehicle 810 and the preceding vehicle 820.

For example, a 1^{st} point 811, a 2^{nd} point 812, a 3^{rd} point 813, a 4^{th} point 814, and a 5^{th} point 815 may represent expected movement points of the vehicle 810 at intervals of a specified time (e.g., 100 ms). A 6^{th} point 821, a 7^{th} point 822, an 8^{th} point 823, a 9^{th} point 824, and a 10^{th} point 825 may represent expected movement points of the preceding vehicle 820 at intervals of the same time. The vehicle 810 may determine a probability of collision between the vehicle 810 and the preceding vehicle 820 in consideration of a location (e.g., the 1^{st} point 811) of the vehicle 810 and a location (e.g., the 6^{th} point 821) of the preceding vehicle 820 in the same time. In the case shown in FIG. 8, all of a distance between the 1^{st} point 811 and the 6^{th} point 821, a distance between the 2^{nd} point 812 and the 7^{th} distance 822, a distance between the 3^{rd} point 813 and the 8^{th} point 823, a distance between the 4^{th} point 814 and the 9^{th} point 824, and a distance between the 5^{th} point 815 and the 10^{th} point 825 are sufficient, so the vehicle 810 may determine that there is no probability of collision between the vehicle 810 and the preceding vehicle 820.

Referring to FIG. 9, a 1^{st} point 911, a 2^{nd} point 912, a 3^{rd} point 913, and a 4^{th} point 914 may represent expected movement points of a vehicle 910 at intervals of a specified time (e.g., 100 ms). A 6^{th} point 921, a 7^{th} point 922, a 8^{th} point 923, and a 9th point 924 may represent expected movement points of a preceding vehicle 920 at intervals of the same time. The vehicle 910 may determine a probability of collision between the vehicle 910 and the preceding vehicle 920 in consideration of a location (e.g., the 1^{st} point 911) of the vehicle 910 and a location (e.g., the 6^{th} point 921) of the preceding vehicle 920 in the same time. In the case shown in FIG. 9, a distance between the 3^{rd} point 913 and the 8^{th} point 923 is close to each other (is less than a specified value), so the vehicle 910 may determine that there is a probability of collision between the vehicle 910 and the preceding vehicle 920.

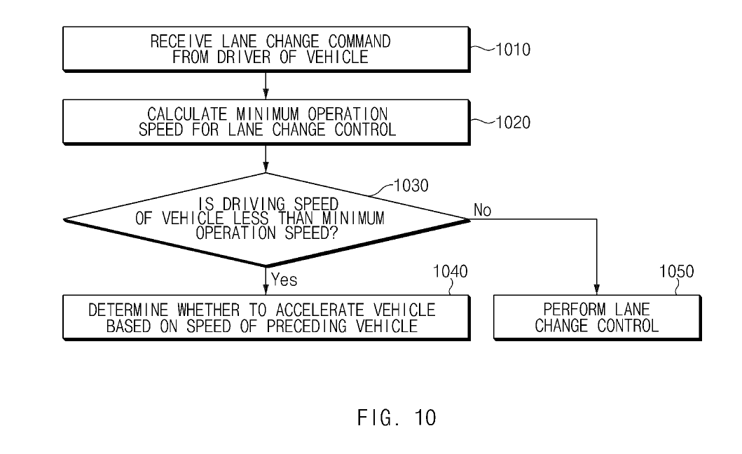

FIG. 10 is a flowchart illustrating a method for controlling a lane change in a vehicle according to an exemplary form of the present disclosure.

Hereinafter, it may be assumed that an apparatus 100 of FIG. 1 performs a process of FIG. 10. Furthermore, in a description of FIG. 10, an operation described as being performed by an apparatus may be understood as being controlled by a control circuit 150 of the apparatus 100.

Referring to FIG. 10, in operation 1010, the apparatus may receive a lane change command from a driver of a vehicle. For example, the apparatus may verify an intention for the driver to perform a lane change, through a turn signal lever, a button, a switch, or the like.

In operation 1020, the apparatus may calculate a minimum operation speed for lane change control. For example, the apparatus may calculate a minimum operation speed based on a measurement value for a following vehicle when the following vehicle is detected or based on a setting value when the following vehicle is not detected.

In operation 1030, when receiving a lane change command, the apparatus may determine whether a driving speed of the vehicle is lower than the minimum operation speed. For example, the apparatus may compare the calculated minimum operation speed with a current speed of the vehicle.

When the driving speed of the vehicle is lower than the minimum operation speed, in operation 1040, the apparatus may determine whether to accelerate the vehicle based on a speed of a preceding vehicle. For example, the apparatus may determine whether to accelerate the vehicle based on a speed of the preceding vehicle, a distance between the vehicle and the preceding vehicle, and/or the like. The vehicle may change a lane after acceleration control or may retry lane change control after deceleration control.

When the driving speed of the vehicle is higher than the minimum operation speed, in operation 1050, the apparatus may perform lane change control. For example, when it is verified that the driving speed of the vehicle is higher than the minimum operation speed, the apparatus may immediately initiate lane change control.

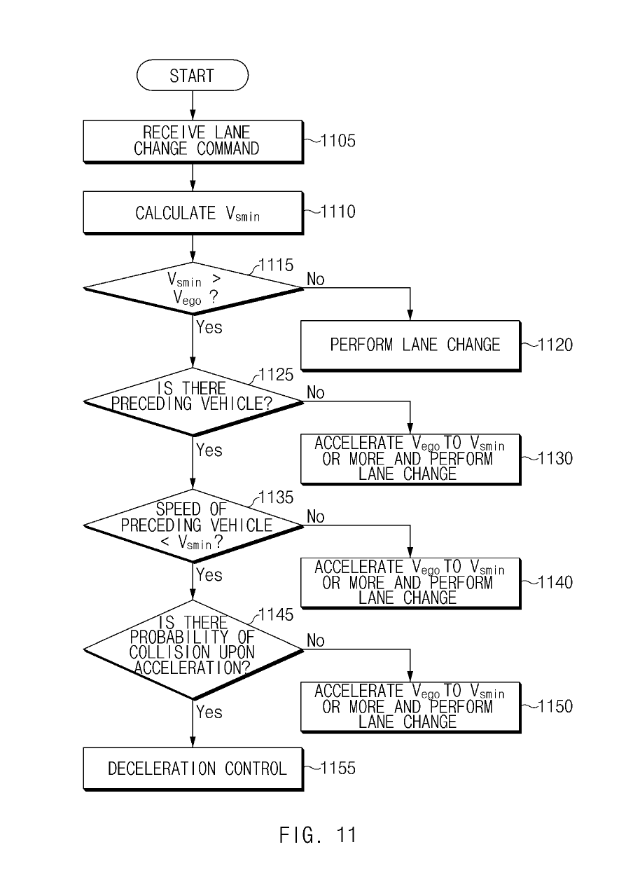

FIG. 11 is a flowchart illustrating a method for controlling a lane change in a vehicle according to an form of the present disclosure.

Hereinafter, it may be assumed that an apparatus 100 of FIG. 1 performs a process of FIG. 11. Furthermore, in a description of FIG. 11, an operation described as being performed by an apparatus may be understood as being controlled by a control circuit 150 of the apparatus 100.

Referring to FIG. 11, in operation 1105, the apparatus may receive a lane change command. In operation 1110, the apparatus may calculate a minimum operation sped Vₛₘᵢₙ for lane change control. In operation 1115, the apparatus may determine whether the minimum operation speed Vₛₘᵢₙ is greater than a driving speed V_{ego} of a vehicle. When the minimum operation speed Vₛₘᵢₙ is less than or equal to the driving speed V_{ego} of the vehicle, in operation 1120, the apparatus may perform a lane change. When the minimum operation speed Vₛₘᵢₙ is greater than the driving speed V_{ego} of the vehicle, in operation 1125, the apparatus may determine whether there is a preceding vehicle.

When there is no the preceding vehicle, in operation 1130, the apparatus may accelerate the driving speed V_{ego} of the vehicle to the minimum operation speed Vₛₘᵢₙ or more and may change a lane. When there is the preceding vehicle, in operation 1135, the apparatus may determine whether a speed of the preceding vehicle is less than the minimum operation speed Vₛₘᵢₙ. When the speed of the preceding vehicle is greater than or equal to the minimum operation speed Vₛₘᵢₙ, in operation 1140, the apparatus may accelerate the driving speed V_{ego} of the vehicle to the minimum operation speed Vₛₘᵢₙ or more and may change the lane. When the speed of the preceding vehicle is less than the minimum operation speed Vₛₘᵢₙ, in operation 1145, the apparatus may determine a probability of collision between the vehicle and the preceding vehicle upon acceleration. When there is no the probability of collision between the vehicle and the preceding vehicle upon acceleration, in operation 1150, the apparatus may accelerate the driving speed V_{ego} of the vehicle to the minimum operation speed Vₛₘᵢₙ or more and may change the lane. When there is the probability of collision between the vehicle and the preceding vehicle upon acceleration, in operation 1155, the apparatus may perform deceleration control.

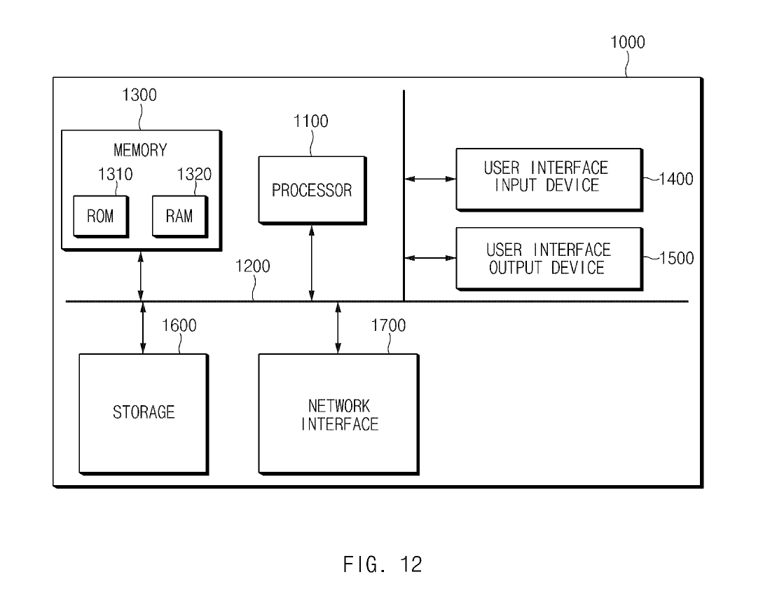

FIG. 12 is a block diagram illustrating a configuration of a computing system according to an form of the present disclosure.

Referring to FIG. 12, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for performing processing of instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the forms disclosed in the specification may be directly implemented with a hardware module, a software module, or combinations thereof, executed by the processor 1100. The software module may reside on a storage medium (i.e., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component of the user terminal.

The apparatus according to an exemplary form of the present disclosure may enhance the convenience of a driver and may provide safety of lane change control by determining whether to accelerate a vehicle in consideration of a speed, a location, and the like of a preceding vehicle when a driving speed of the vehicle is lower than a minimum operation speed.

In addition, various effects directly or indirectly ascertained through the present disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An apparatus for controlling a lane change of a vehicle, the apparatus comprising:
a sensor configured to sense an external vehicle;
an input device configured to receive a lane change command from a driver of the vehicle; and
a control circuit configured to be electrically connected with the sensor and the input device,
wherein the control circuit is configured to:
receive the lane change command using the input device;
calculate a minimum operation speed of the vehicle for a lane change control; and
determine whether to accelerate the vehicle based on a speed of a preceding vehicle traveling on the same lane as the vehicle, when a driving speed of the vehicle is lower than the minimum operation speed.

2. The apparatus according to claim 1, wherein the control circuit is configured to:
calculate the minimum operation speed of the vehicle in response to receiving the lane change command.

3. The apparatus according to claim 1, wherein the control circuit is configured to:
calculate the minimum operation speed of the vehicle periodically while the vehicle travels.

4. The apparatus according to claim 1, wherein the control circuit is configured to:
when a following vehicle traveling on a target lane corresponding to the lane change command is sensed by the sensor, calculate the minimum operation speed based on a speed of the following vehicle and a distance between the vehicle and the following vehicle.

5. The apparatus according to claim 1, wherein the control circuit is configured to:
when a following vehicle traveling on a target lane corresponding to the lane change command is not sensed by the sensor, calculate the minimum operation speed based on a predetermined speed for traveling vehicles and a sensing distance corresponding to a maximum distance sensible by the sensor.

6. The apparatus according to claim 1, wherein the control circuit is configured to:
control the vehicle such that the driving speed of the vehicle is higher than the minimum operation speed, when the minimum operation speed is lower than the speed of the preceding vehicle; and
perform the lane change control.

7. The apparatus according to claim 1, wherein the control circuit is configured to:
control the vehicle such that the driving speed of the vehicle is higher than the minimum operation speed, when the preceding vehicle is not sensed by the sensor; and
perform the lane change control.

8. The apparatus according to claim 1, wherein the control circuit is configured to:
determine whether to accelerate the vehicle based on the speed of the preceding vehicle and a distance between the vehicle and the preceding vehicle, when the minimum operation speed is higher than the speed of the preceding vehicle.

9. The apparatus according to claim 8, wherein the control circuit is configured to:
determine a probability of collision between the vehicle and the preceding vehicle based on the speed of the preceding vehicle and the distance between the vehicle and the preceding vehicle;
control the vehicle such that the driving speed of the vehicle is higher than the minimum operation speed, when there is no the probability of collision; and
perform the lane change control.

10. The apparatus according to claim 9, wherein the control circuit is configured to:
estimate a predicted driving path of the vehicle and a predicted driving path of the preceding vehicle based on the speed of the preceding vehicle and the distance between the vehicle and the preceding vehicle; and
determine the probability of collision between the vehicle and the preceding vehicle based on the predicted driving path of the vehicle and the predicted driving path of the preceding vehicle.

11. The apparatus according to claim 8, wherein the control circuit is configured to:
determine a probability of collision between the vehicle and the preceding vehicle based on the speed of the preceding vehicle and the distance between the vehicle and the preceding vehicle; and
control the vehicle to decelerate, when there is the probability of collision.

12. The apparatus according to claim 11, wherein the control circuit is configured to:
determine the probability of collision, after the vehicle decelerates.

13. The apparatus according to claim 11, wherein the control circuit is configured to:
calculate the minimum operation speed again, after the vehicle decelerates.

14. A method for controlling a lane change in a vehicle, the method comprising:
receiving, by a control circuit, a lane change command from a driver of the vehicle;
calculating, by the control circuit, a minimum operation speed of the vehicle for a lane change control; and
determining, by the control circuit, whether to accelerate the vehicle based on a speed of a preceding vehicle traveling on the same lane as the vehicle, when a driving speed of the vehicle is lower than the minimum operation speed.

15. The method according to claim 14, wherein calculating the minimum operation speed comprises:
when a following vehicle traveling on a target lane corresponding to the lane change command is sensed, calculating the minimum operation speed based on a speed of the following vehicle and a distance between the vehicle and the following vehicle.

16. The method according to claim 14, wherein calculating the minimum operation speed comprises:
when a following vehicle traveling on a target lane corresponding to the lane change command is not sensed, calculating the minimum operation speed based on a predetermined speed of traveling vehicles set by a country where the vehicle is located, and a sensing distance corresponding to a maximum distance sensible by a sensor of the vehicle.

17. The method according to claim 14, further comprising:
controlling, by the control circuit, the vehicle such that the driving speed of the vehicle is higher than the minimum operation speed, when the minimum operation speed is lower than the speed of the preceding vehicle; and
performing the lane change control.

18. The method according to claim 14, further comprising:
controlling, by the control circuit, the vehicle such that the driving speed of the vehicle is higher than the minimum operation speed, when the preceding vehicle is not sensed; and
performing the lane change control.

19. The method according to claim 14, wherein determining whether to accelerate the vehicle comprises:
determining whether to accelerate the vehicle based on the speed of the preceding vehicle and a distance between the vehicle and the preceding vehicle, when the minimum operation speed is higher than the speed of the preceding vehicle.

20. The method according to claim 19, further comprising:
determining, by the control circuit, a probability of collision between the vehicle and the preceding vehicle based on the speed of the preceding vehicle and the distance between the vehicle and the preceding vehicle;
controlling, by the control circuit, the vehicle such that the driving speed of the vehicle is higher than the minimum operation speed, when there is no the probability of collision; and
performing, by the control circuit, the lane change control.
